(19) United States
(12) Patent Application Publication
(10) Pub. No.: US 2016/0230456 A1
(43) Pub. Date: Aug. 11, 2016

(54) Apparatus and Method for Preventing Vertical Blind Vane Swaying

(71) Applicant: John I. Trujillo, El Cajon, CA (US)

(72) Inventor: John I. Trujillo, El Cajon, CA (US)

(21) Appl. No.: 14/615,658

(22) Filed: Feb. 6, 2015

(51) Int. Cl. E06B 9/36; E06B 9/38

(52) U.S. Cl. CPC E06B 9/36; E06B 9/38

(57) ABSTRACT

An apparatus and method for preventing swaying of vertical blind vanes is provided wherein a tensioned cord is positioned between the vertical vanes and the window sill, said cord being coupled to anchoring means that are anchored to the insides of the window frame. The cord runs through a plurality of clips coupled with eyelet holes, said clips being attached to the bottom edges of the vanes at the vanes' mid-point, allowing the vanes to rotate. A plurality of vertical blind vanes having curled lateral edges is also provided wherein said curled lateral edges cause the vanes to interlock when they are in a closed position.

### FIELD OF THE INVENTION

The present invention is directed generally to vertical blinds used to shade the interior of buildings, and more particularly, to an apparatus and method for preventing vertical blind vanes from swaying.

### BACKGROUND OF THE INVENTION

Most vertical blinds hang freely from a head rail using clips at the top of each vane located at the center of the vertical rotation of the vanes. The horizontal spacing and rotation of the clips about a vertical axis of rotation is controlled by a mechanism in the head rail that in turn is controlled by cords or rods operated by a user.

The vanes are generally free to swing about their points of attachment to the head rail in axes perpendicular to the vertical axis of rotation. The vanes are often made of a flexible material, which allows them to bend and twist. The vanes can easily sway or rattle individually in the wind, a house fan, or in response to users touching them, causing noise when the vanes collide with each other. Swaying or flapping can cause vanes to become stuck in the window track, leaving a gap between the vanes which compromises privacy. Excessive swaying or flapping can cause vanes to break at the top where they are attached to the head rail.

The prior art teaches several means for stabilizing vertical vanes to reduce rattling or swaying movement, including chains attached to the lower part of the vanes and complicated foot rail apparatuses. The chains tend to be highly visible and unsightly and still allow vertical vanes to sway to such an extent that they provide limited or no noise reduction. The foot rail apparatuses tend to be highly visible, complex and difficult to install. An object of the present invention is to overcome the above disadvantages in the prior art by providing an apparatus and method for preventing vertical blind vane rattling and swaying which is highly effective, minimally visible and easy to install.

### SUMMARY OF THE INVENTION

A first aspect of the present invention provides a cord positioned between the vertical vanes and the window sill. Said cord runs the width of the vertical blinds and, in one embodiment of the present invention, is stabilized by being coupled to anchoring means that are anchored to the insides of the window frame. A plurality of clips coupled with eyelet holes is also provided. The cord runs through the eyelet holes. The clips are attached to the bottom edges of the vanes at the vanes' mid-point, allowing the vanes to rotate. The cord is tensioned such that any pendulum motion of the vertical vanes is prevented. The eyelet holes provide a stable means of coupling the cord to the clips while allowing movement of the vanes along the plane of the cord.

Brackets can be used to stabilize the cord for vertical blinds on windows that are not inside of a window frame and instead are hung from the wall with the head rail anchored to the wall above the window. In this embodiment of the present invention, the brackets are attached to the wall on either side of the vertical blinds and are of sufficient size to position the cord below the vertical vanes.

A second aspect of the present invention provides a plurality of vertical blind vanes having curled lateral edges. On each vane, one lateral edge curls toward one surface of the vane while the other lateral edge curls toward the opposite surface of the vane, such that the lateral edges of adjacent vanes interlock when the vanes are in a closed position, inhibiting the pendulum movement of the vanes. The second aspect of the present invention may be employed in conjunction with the first aspect of the present invention or may be practiced separately as a means to reduce pendulum movement in vertical vane blinds on its own.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a front plan view of the first aspect of the present invention;

FIG. 2 illustrates a front perspective view of the first aspect of the present invention;

FIG. 3 illustrates an enlarged perspective view of the clip/eyelet hole component of the first aspect of the present invention;

FIG. 4 illustrates a perspective view of the second aspect of the present invention;

FIG. 5 illustrates an enlarged perspective view of the second aspect of the present invention;

### DETAILED DESCRIPTION

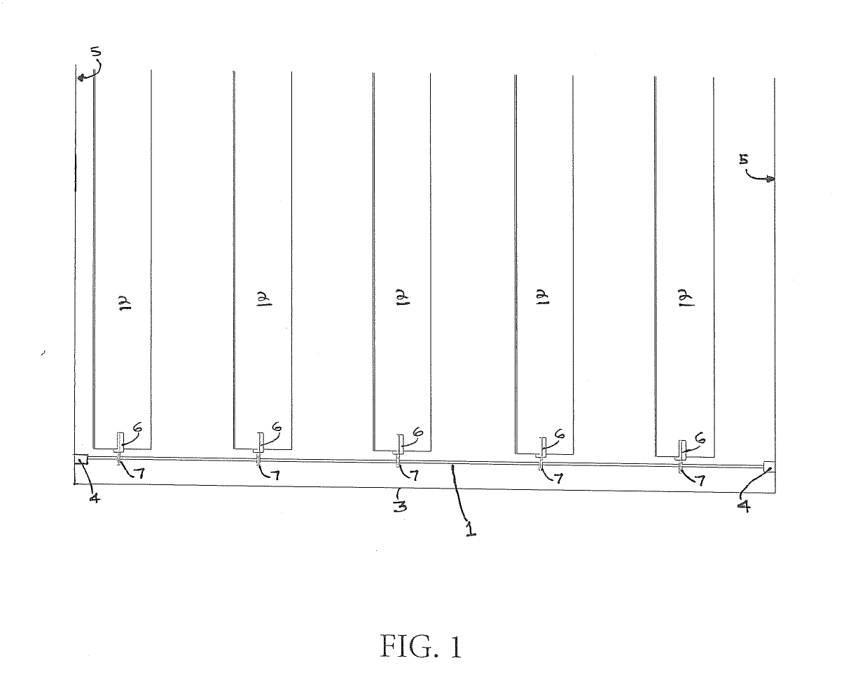

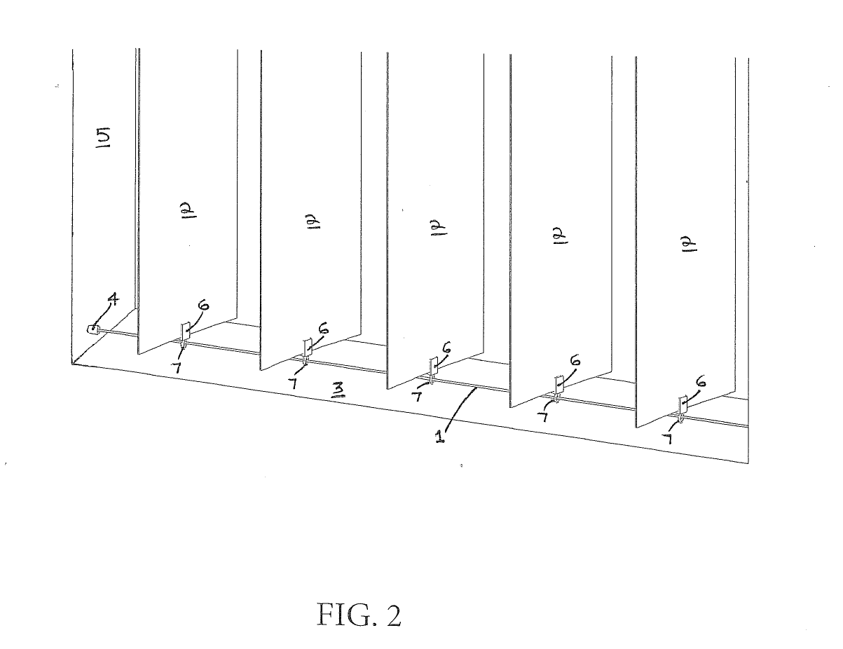

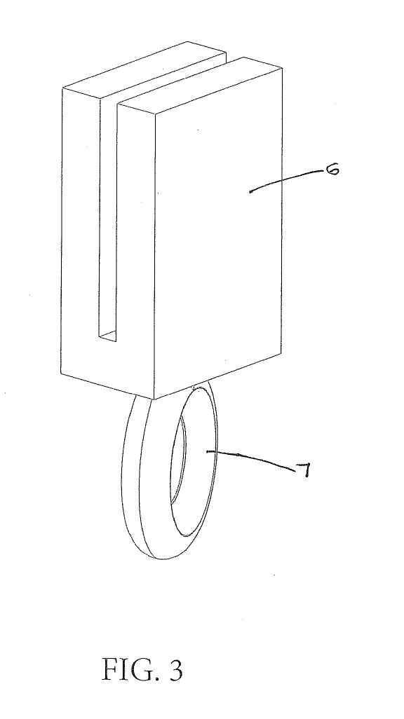

FIGS. 1-3 illustrate the first aspect of the present invention wherein a cord 1 is positioned between vertical vanes 2 and window sill 3. Cord 1 runs the width of the vertical blinds and, in one embodiment of the present invention, is stabilized by being coupled to anchoring means 4 that are anchored to the insides of the window frame 5. A plurality of clips 6 coupled with eyelet holes 7 are also provided. Cord 1 runs through eyelet holes 7. Clips 6 are attached to the bottom edges of vanes 2 at the vanes' mid-point, allowing vanes 2 to rotate. Cord 1 is tensioned such that any pendulum motion of the vertical vanes is prevented. Eyelet holes 7 provide a stable means for coupling cord 1 to clips 6 while allowing movement of vanes 2 along the plane of cord 1.

Brackets can be used to stabilize cord 1 for vertical blinds on windows that are not inside of a window frame and instead are hung from the wall with the head rail anchored to the wall above the window. In this embodiment of the present invention, the brackets are attached to the wall on either side of the vertical blinds and are of sufficient size to position cord 1 below vanes 2.

The first aspect of the present invention may be easily installed on most standard vertical blind sets by positioning cord 1 below vanes 2 and securing cord 1 in a tensioned manner by means of anchoring means 4 to the sides of the window frame 5 or brackets on the sides of the window for vertical blind sets installed on windows without frames.

Cord 1 may be made of a variety of materials suitable to provide the necessary strength and tension while being minimally visible (i.e. having a small diameter and preferably transparent). For example, cord 1 may be a fishing line, or a similarly small-diameter cord made of nylon, polyethylene, metal, etc.

Clips 6 are preferably transparent and made of a hard, slightly elastic plastic material such that clips 6 are easily installed by sliding them onto the bottoms of vanes 2, yet tightly and securely grip vanes 2 once installed. Clips 6 may be made of materials other than plastic which are capable of sliding onto and gripping vanes 2, such as metal.

Anchoring means 4 comprises any means known in the art for securing a cord, such as crimped metal, coupled with a wall screw or any other means known in the art for coupling anchoring means 4 to the sides of window frame 5.

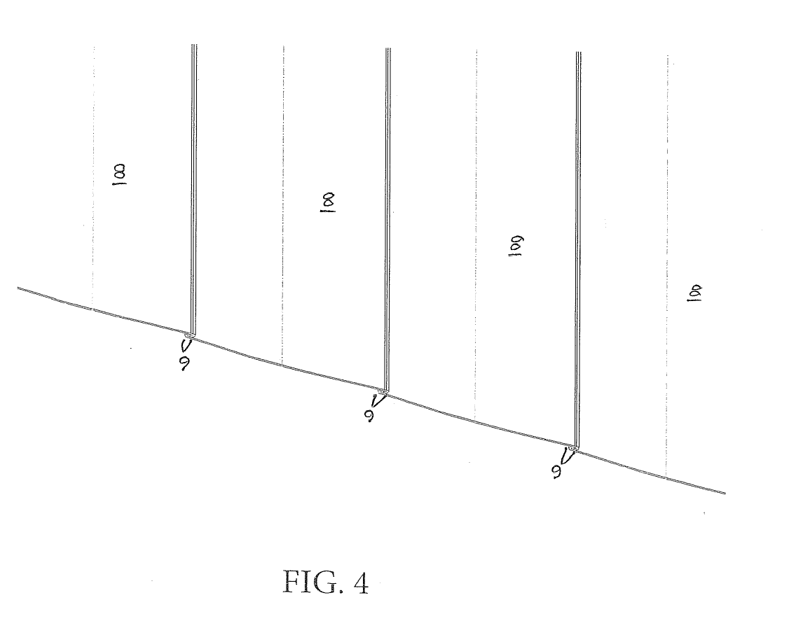

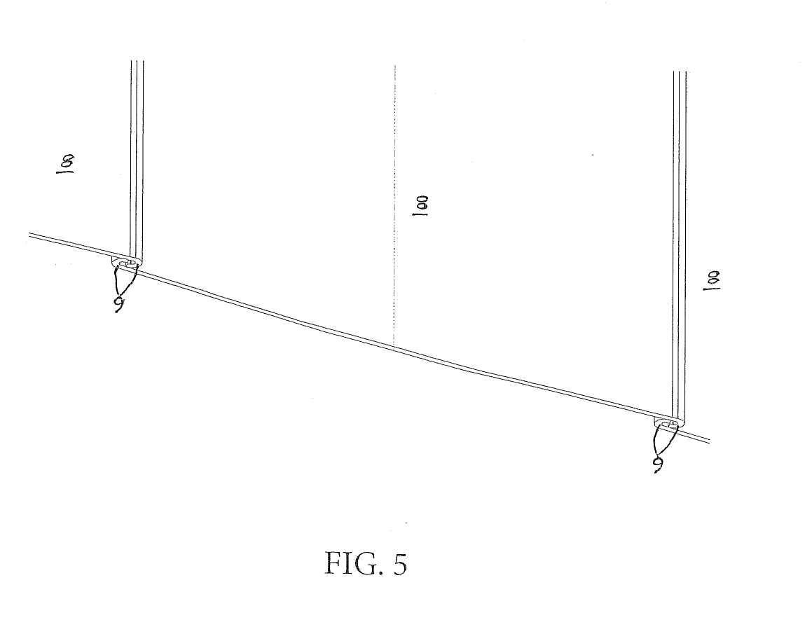

FIGS. 4 and 5 illustrate the second aspect of the present invention provides a plurality of vertical blind vanes 8 having curled lateral edges 9. On each vane 8, one lateral edge 9 curls toward one surface of vane 8 while the other lateral edge 9 curls toward the opposite surface of vane 8, such that lateral edges 9 of adjacent vanes 8 interlock when vanes 8 are in a closed position, inhibiting the pendulum movement of vanes 8. The second aspect of the present invention may be employed in conjunction with the first aspect of the present invention or may be practiced separately as a means to reduce pendulum movement in vertical vane blinds on its own.

While the invention is susceptible to various modifications and alternative fauns, specific embodiments thereof have been shown by way of example in the drawings and are herein described in detail. It should be understood, however, that the description herein of specific embodiments is not intended to limit the invention to the particular forms disclosed.

What is claimed is:

1. An apparatus for preventing vertical blind vanes from swaying, comprising a cord running through a plurality of clips coupled with eyelet holes, wherein said clips are capable of gripping the bottom of said vanes.

2. The apparatus of claim 1, further comprising anchoring means coupled to each end of said cord, said anchoring means being capable of attaching to the sides of a window frame to secure said cord in a tensioned position below said vanes.

3. The apparatus of claim 1, further comprising brackets coupled to each end of said cord, said brackets being capable of attaching to the wall on each side of a window and securing said cord in a tensioned position below said vanes.

4. The apparatus of claim 1, wherein said clips are attached to the bottom edges of said vanes at the vanes' mid-point, and wherein said cord is tensioned such that the pendulum motion of said vanes is prevented.

5. A method for preventing vertical blind vanes from swaying, comprising:
a) providing a cord running through a plurality of clips coupled with eyelet holes, wherein said clips are capable of gripping the bottom of said vanes;
b) securing said cord below said vanes;
c) coupling each end of said cord to the sides of a window frame or the walls on each side of a window; and
d) attaching said clips to the bottom edges of said vanes at the vanes' mid-point;
wherein said cord is tensioned such that the pendulum motion of said vanes is prevented.

6. An apparatus for preventing vertical blind vanes from swaying, comprising a plurality of vanes having curled lateral edges, wherein one lateral edge of each vane curls toward one surface of vane while the other lateral edge curls toward the opposite surface of vane, such that the lateral edges of adjacent vanes interlock when said vanes are in a closed position.

7. The apparatus according to claim 1, further comprising the apparatus according to claim 6.
